(19) United States
(12) Patent Application Publication
(10) Pub. No.: US 2007/0250258 A1
(43) Pub. Date: Oct. 25, 2007

(54) Method and System for Accurate Reconstruction of Mileage Reports

(75) Inventor: E. Elizabeth Hager, San Francisco, CA (US)

Correspondence Address: LINER YANKELEVITZ SUNSHINE AND REGENSTREIF, 1100 GLENDON AVENUE, 14TH FLOOR, LOS ANGELES, CA, 90024, US

(73) Assignee: IIMAP, LLC, San Francisco, CA (US)

(21) Appl. No.: 11/458,929

(22) Filed: Jul. 20, 2006

Related U.S. Application Data
(60) Provisional application No. 60/702,523, filed on Jul. 21, 2005.

(51) Int. Cl. G01C 21/00

(52) U.S. Cl. 701/201; 701/200

(57) ABSTRACT

A method or system for accurately reconstructing mileage and travel expense, wherein a user inputs travel information including addresses for a starting location, intermediate destination points, an end location, and the purpose of the trip. A routing system determines a route from the starting point through all of the intermediate destination points to the end point. This route is made up of segments which are the portions of the route between any two addresses. A mileage calculation system then obtain the length of each of the segments, and a rate calculation system calculates the expense rate to apply to each of the segments based on the character of the segment. A summary calculation system then calculates the expense of a trip along each of the segments and outputs a report for the user to submit as an expense report, support a tax deduction, or keep for their records.

### CROSS-REFERENCE TO PRIOR APPLICATIONS

This application is based upon, and claims the priority date of provisional Application No. U.S. 60/702,523 with filing date of Jul. 21, 2005 which is incorporated herein by reference.

### BACKGROUND OF THE INVENTION

1. Area of the Art

This invention relates generally to route calculation, and travel and mileage logs, and, more particularly, to a method and system for automatically calculating and tabulating route and mileage information for the purpose of expense reports and tax deductions.

2. Description of the Prior Art

Approximately 18% of all domestic travel in the United States is made for business purposes. Employers often reimburse business travelers for the expenses they incur during these business trips, or, alternatively, a traveler may deduct a portion of these business travel expenses on their taxes. For instance, the IRS has promulgated a standard mileage rate, currently 40.5 cents per mile, for calculating the expense associated with business travel in the traveler's personal automobile. The mileage rate is periodically revised so that different taxable years may use different rates. Employers often use this rate to calculate reimbursement. In addition, this rate may also be used to calculate tax deductions for medical expenses and charitable contributions. As a result, there are various products and methods known in the art for keeping track of the mileage of a traveler and for calculating the reimbursement or deduction expense associated with each trip.

Perhaps the oldest and most widely used method of keeping track of business travel mileage is a paper odometer log, in which a traveler manually records the odometer reading at the start of the business trip and the odometer reading at the end of the business trip. The log may also contain a column for the actual mileage traveled, derived from the subtraction of the starting odometer value from the ending odometer value, as well as columns for the date, and description of a particular trip. The user must manually calculate the mileage for a trip, as well as the total mileage and expense for trips in a given month or year.

A current variation of this method for keeping track of business travel mileage is to use mapping software, such as MapQuest or Google Maps, to determine the distance of a trip, rather than taking odometer readings at the start and end of a business trip. Although this method may not be as accurate as taking odometer readings, it is much more convenient for the user. The user must still, however, record the mileage numbers manually in a paper log or spreadsheet, sum the mileage over a given time period, and calculate the total travel expense for that time period.

Digital odometer logs are also currently known in the art. These software applications are installed on handheld devices or Personal Computers, and provide spread-sheet reports or customized form reports. The reports may track total mileage, vehicle maintenance, and travel costs. While these applications simplify the tabulation and calculation of mileage totals, and travel costs, a user still must manually enter odometer readings or mileage values into the digital odometer log. Moreover, digital odometer logs do not calculate deductible or reimbursable expenses automatically from the travel mileage.

There are, however, applications that estimate mileage for the purpose of calculating shipping charges. To simplify mileage calculations for long distance travel, navigable map routing applications have been used in the trucking industry for a number of years. These personal computer based applications calculate shipping rates by using navigable maps to determine the mileage to a destination, and then multiply the mileage by a per mile shipping rate. In addition to the calculation of shipping costs and travel expenses, many navigable map routing applications can also calculate routes for a truck based on selected parameters. For instance, a truck route may be selected according to distance of the route, speed of the route, cost of the route, or standard routes. Navigable map routing applications also have the capability to determine the costs associated with a given travel route, including: maintenance, tolls, fuel costs and taxes. Despite the capability of these programs to estimate mileage values and calculate some of the costs associated with trucking routes, these programs have not been used to calculate or tabulate the mileage values, reimbursement amounts, or deductions associated with business travel, or other deductible travel, using a personal automobile.

Most navigable map routing applications are based on the Household Goods (HHG) Mileage Guide created by Rand McNally in 1936. The HHG Mileage Guide is a compilation of mileage data for county roads within the United States, and is a useful tool for determining truck routes between destinations. The HHG Mileage Guide is of limited use, however, for short trips or business trips within a city. The HHG uses a single mileage point within a city, including a city that covers a large geographical area such as Los Angeles, to calculate the mileage between that city and a destination or starting point. As a result, the HHG Mileage Guide cannot be used calculate the mileage of intra-city trips, and may be grossly inaccurate for short trips outside of a city.

Products and methods utilizing Global Positioning System (“GPS”) technology can be used to calculate travel mileage within a state for the purpose of determining various state highway taxes. These methods require a traveler to have a GPS device within their automobile. Moreover, there are currently no products or methods that use GPS data to calculate reimbursement for business travel using a personal car or IRS deductions for car travel expenses.

### SUMMARY OF THE INVENTION

Therefore, it is an object of the current invention to overcome the aforementioned limitations of the prior art, and provide a device, method, and system for users to accurately and automatically reconstruct business, medical and charity mileage, and tally it for personal records, expense reports and tax deductions. The present invention may provide this functionality by means of software (for example in conjunction with a person computer (“PC”)), or by means of a system comprised of a conventional Internet browser, an Internet enabled device, such as a PC, personal data assistant (“PDA”), or Internet enabled cellular phone (“smart phone”), and Internet connected web servers.

The inventive method or system calculates travel expense and deduction information by analyzing starting point and destination address data input by a user. A user may manually input this data, or, alternatively, address data may be downloaded from a user's electronic appointment diary. In addition to address information, information regarding the date of the trip, purpose of the trip, client information, and other descriptive notes may also be input by the user or downloaded from their appointment diary. The travel information is tabulated and stored for personal records, use in expense reports, or to support tax deductions.

Once the travel information is input or downloaded, the relative location of starting point and destination are calculated. The shortest path between the starting points and destination are then obtained either through analysis of a vector map of the roads connecting the starting point and the destination, or through third party mapping and routing software which derive the information from a vector map or the like. This path is used to estimate accurately the driving distance between the locations, which is then tabulated and stored along with the associated trip information.

The tabulated mileage and trip information may also undergo additional processing to output data useful to a user. For instance, the expense (for reimbursement purposes) or the deduction (for tax purposes) of a trip may be determined by multiplying the mileage value by an mileage rate, such as the current standard IRS mileage deduction rate of 40.5 cents per mile or an employer's rate. Moreover, statistical analyses may be run on tabulated mileage and expense information, and/or travel and expense data may be sorted by date or other criteria. In addition, multi-stop trips may be analyzed, and the mileage and expenses for a given trip may be validated. A user may supplement trip expenses by entering parking and toll expenses. All this additional trip data may also be tabulated and stored with the associated trip data.

The current invention may also incorporate GPS information and devices to calculate travel statistics and expense/deduction amounts. For instance, the current invention may be linked to a user's GPS enabled mobile phone, PDA, or automobile navigation system to provide automatic entry of business travel information, or real time processing of business travel information and expenses.

### DESCRIPTION OF THE FIGURES

FIG. 1 is a flow diagram of a Web based system providing a user with travel statistics or expense information based on the travel information input by the user and/or travel information downloaded from the user's electronic appointment diary.

FIG. 2 is one embodiment of the basic architecture of the Web based system illustrated in FIG. 1.

FIG. 3 is a more detailed flow diagram of the address creation and validation process carried out by the address book and geocoder modules of the Web based system illustrated in FIG. 1.

FIG. 4 is a detailed flow diagram of the route creation process carried out by the trip selection and router modules shown in the Web based system of FIG. 1.

FIG. 5 is a representation of the data tables used by various modules of the Web based system shown in FIG. 1.

FIG. 6 is a screenshot of a Web based embodiment of the present invention illustrating the personal Web page of a user.

FIG. 7 is a screenshot of a Web based embodiment of the present invention illustrating a user's address book for storing trip information.

FIG. 8 is a screenshot of a Web based embodiment of the present invention illustrating a calendar feature for allowing a user to select the dates of a reimbursable or deductible trip.

FIG. 9 is a screenshot of a Web based embodiment of the present invention illustrating the trip selection function allowing a user information for a reimbursable or deductible trip.

### DETAILED DESCRIPTION OF THE INVENTION

The following description is provided to enable any person skilled in the art to make and use the invention and sets forth the best modes contemplated by the inventor of carrying out his invention. At the heart of the current invention is a method of calculating, tabulating and processing travel mileage data derived from address information input or downloaded from a user.

In one embodiment of the inventive method, a user can manually input address information for the starting point, intermediate destination points and end location of a route or trip. In addition to this address information, the user may also input other route/trip information, such as: the date of the trip, the purpose of the trip, client data, and parking, toll or other expenses. This travel information may be stored and used for future trips.

Alternatively, a user's route information may be downloaded from the user's electronic appointment diary, calendar or other automated system that contains such data. For example, travel data, including data relating to the date of the trip, addresses, purpose of the trip and client data may be downloaded from the diary and contact list of the user. In one embodiment of the current invention, the user may have an electronic address book associated with common travel destinations which could be referenced to acquire address and travel data for a given trip. Moreover, a user may manually supplement downloaded data with additional data if they so desire.

The electronic appointment diary can be in the form of a spreadsheet or a planning and scheduling program such as Microsoft Outlook, and the data or application may be stored or executed on a number of electronic devices, such as a user's personal computer, PDA, or cellular phone. The user's travel information may be automatically downloaded from these devices when it is entered into the appointment diary, or, alternatively, the download may be initiated by the user. The automatic download of travel information from a variety of electronic devices, streamlines the travel accounting process, and eliminates the need for a user to duplicate information already entered into their appointment diary.

Once address information is input by or downloaded from a user, the addresses of the starting point, any intermediate destination points, and end location are located on a map. In one embodiment of the current invention, this process is performed by a geocoder which estimates the geographic location of an address through the use of Geographic Information System (GIS) street data, and a process known as address interpolation. The geocoder takes a street address and matches it to a street and street segment or block within the GIS street data. The geocoder then interpolates the address within the range of addresses along that street segment or block, resulting in an estimated geographic location for that address (often in latitude and longitude). In an alternate embodiment of the invention, the geographic location of the addresses may be obtained from a third party mapping application, such as MapQuest or Google Maps (which are effectively automated geocoders).

After the geographic locations of the starting point, intermediate points and end point of a trip are calculated, a path or travel route between the starting address, any intermediate destination points and ending address can be derived. If there are intermediate addresses, the route can be considered to be composed of individual segments between each pair of addresses. This allows one trip to have different expense/deductions rates and purposes for each segment. In one embodiment of the present invention, the route between the addresses will be selected according to whichever possible route is the shortest. In alternate embodiments, routes may be selected according parameters other than overall distance, such as speed limit, traffic patterns, or combinations thereof so that the “fastest” route is selected. The shortest path between the two addresses can be calculated using a pathing algorithm, such as Dijkstra's algorithm, the Bellman-Ford Algorithm, or the A* algorithm. These algorithms may also be used to select the fastest route according to speed limit or traffic patterns. In an alternate embodiment of the present invention, the shortest path between the starting address, intermediate destination points, and ending address may be obtained from third party mapping and routing software, such as MapQuest or Google Maps.

In one embodiment, the shortest path of the segment between the addresses input of downloaded from a user is calculated using Dijkstra's algorithm. In this embodiment, the geographic locations of the starting address, any intermediate destination point(s), and ending address are identified on a vector map (Vmap). The road network connecting the starting and destination addresses, along with any other addresses, are represented in the Vmap as a series of vectors. In Dijkstra's algorithm, the starting point, intermediate points and destination point are represented as vertices, and the road network connecting these addresses are represented as edges. The edges may be weighted according to parameters such as distance, speed limit, traffic or combinations thereof. In a preferred embodiment, the edges are weighted according to the overall length of each road segment. Once the edges between the vertices are weighted, Dijkstra's algorithm finds the path that minimizes the sum of the weights of the edges comprising the path, or the shortest path in a preferred embodiment.

Once this path is calculated, the overall length of the path is determined by summing the magnitudes of the vectors representing the road sub-segments comprising the path. This trip mileage data is then tabulated and stored along with the corresponding travel information. The mileage calculation and tabulation process occurs for every trip downloaded or input by a user. In one embodiment, the user may indicate whether a trip is a round trip, in which case the mileage data may be doubled rather than having to go through the location and mileage calculations again. For multi-stop trips, the distance of each segment of the trip, or portions of the path between the points, may be designated, for example, as related to a different client, as being reimbursable, as having tax significance or as a being personal trip.

In an alternate embodiment of the inventive method, the route and mileage of route segments is directly tracked using GPS hardware and software. The addresses along the route divide the route into segments, and these segment lengths may be reported by the GPS hardware and software. In one embodiment, the method may automatically or wirelessly obtain mileage and route information from a user's GPS system. Moreover, this GPS mileage and route data may be verified, as will be discussed later, by determining the mileage of the shortest route between the input addresses according to methods described above.

Once the mileage data is stored along with the corresponding trip information, it may be displayed to a user in the form of a spreadsheet, graphical data, or as a form report. Alternatively, the data may undergo additional processing to make them more useful to the user. In one embodiment of the current method, the mileage data are further processed to yield expense data for all reimbursable or deductible trips in a given month, year or time interval (i.e., fiscal year for a given company). For instance, the travel expense for trips can be calculated by multiplying mileage data by an applicable expense/deduction rate, such as the standard current IRS expense rate of 40.5 cents per mile for business trips using a personal automobile.

Statistical analysis of mileage and expense data may also be performed and output for the user. In one embodiment, the current method calculates and displays the average expense business travel within a given month or year, the average expense per client, or other statistics as selected by the user. Moreover, mileage and expense data can also be sorted according to pre-defined parameters or parameters selected by a user. For example, mileage and expense data can be sorted according to client, date, and expense. In one embodiment of the current method, the method may calculate the percentage of differing use, such as trips for personal, business, charitable, or other deductible purpose, for a given odometer range entered by the user.

In addition to the data processing and sorting mentioned above, the current inventive method may also be used by an employer or traveler to validate the mileage and expense of business or other deductible travel. Using the method, a reimbursing entity can calculate the mileage and expense for the shortest route of reimbursable travel for a given traveler. If a claim for reimbursement is significantly greater than this amount the reimbursing entity may flag the claim and deal with it accordingly. This method of verifying the expense for reimbursable travel is useful for reimbursing entities because previously, unless travel expenses or mileage are grossly exaggerated, most employers, or other reimbursing entities, have no way of verifying whether travel distance or expense is legitimate.

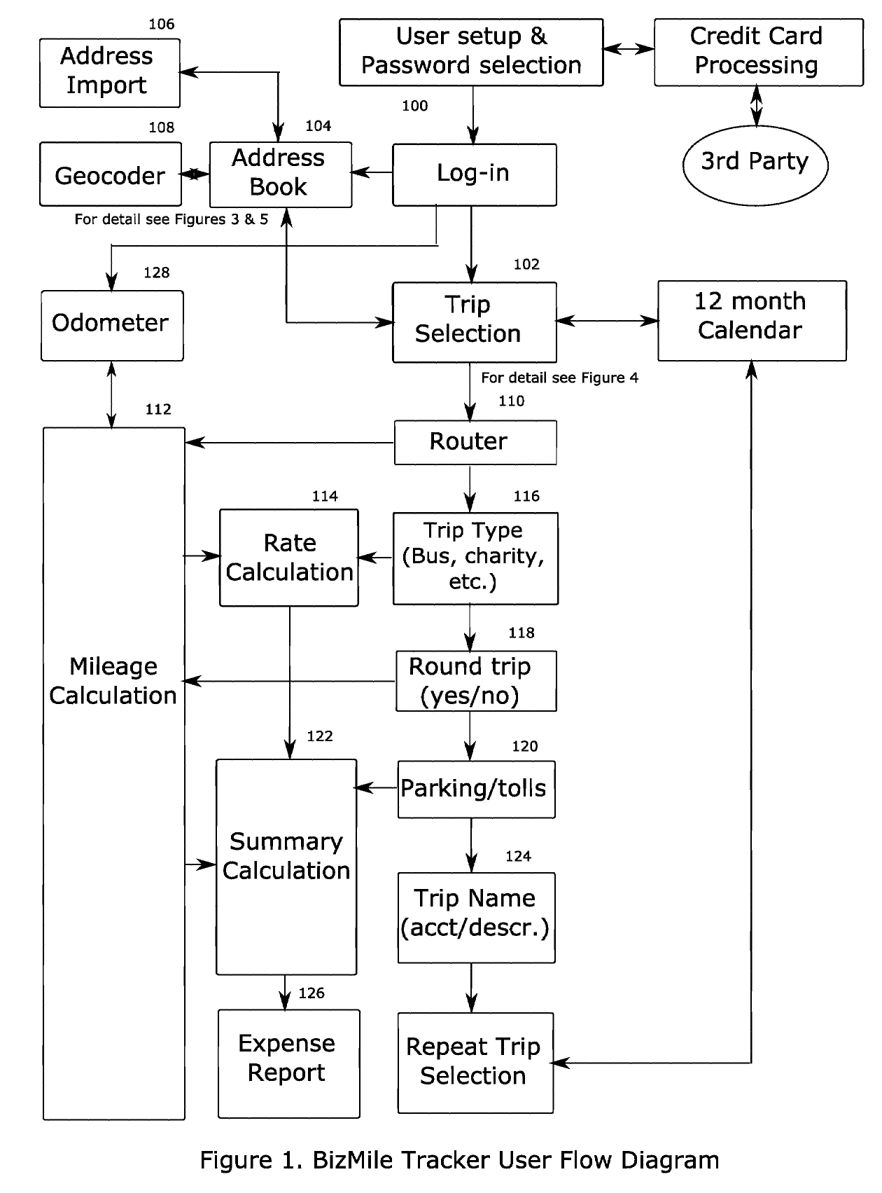

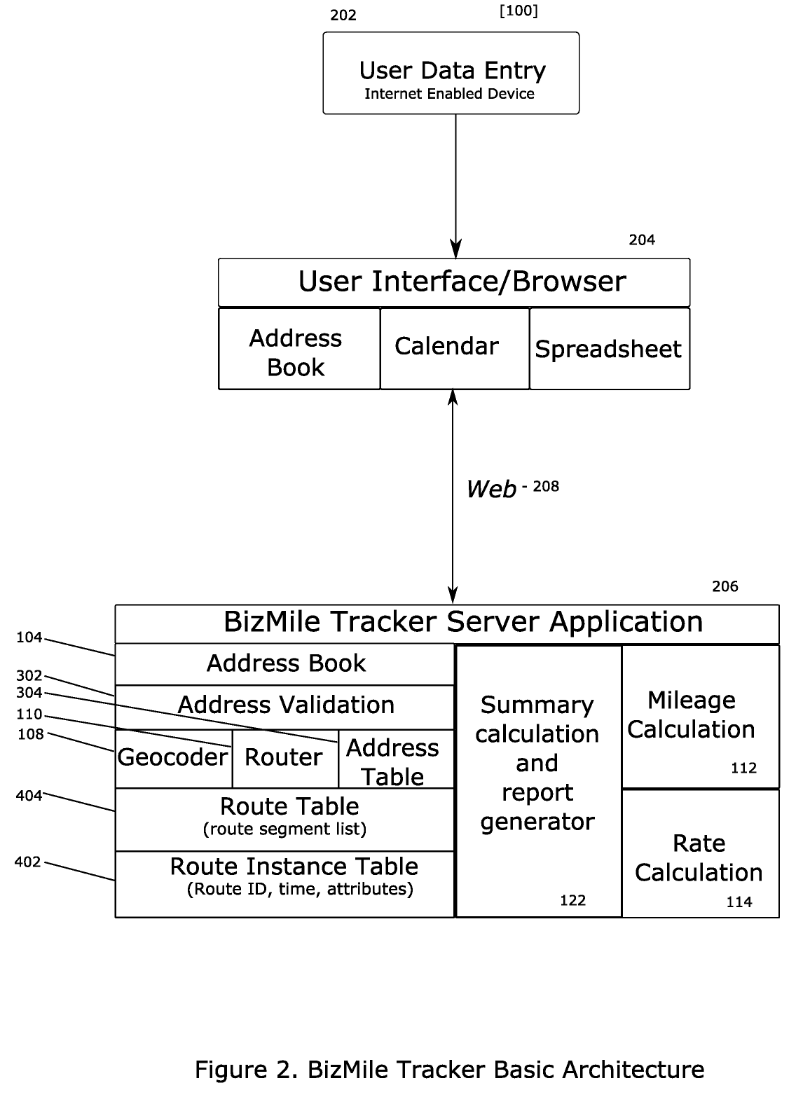

In an alternate embodiment, represented in FIGS. 1 and 2, the inventive method described above may be incorporated into an Internet based system 100 for calculating, tabulating, and processing reimbursable or deductible travel mileage and expenses. To access this system all that is required is an Internet browser 204 and an Internet enabled device 202, such as a personal computer, PDA, or “smart” phone. In this system, a user can access, via the Internet 208, a server 206 containing a Web page specific to their travel and expense information. From this Web page a trip selection module 102 will prompt the user to enter trip information, such as the starting address, any intermediate destination addresses, ending address, date of travel, purpose of the trip, description, and client identification. The user may enter this information for a number of recent or past trips.

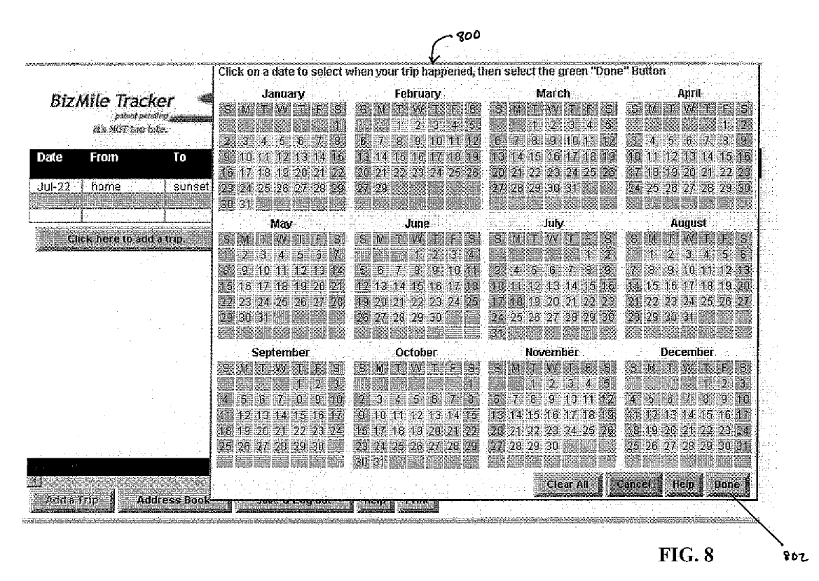

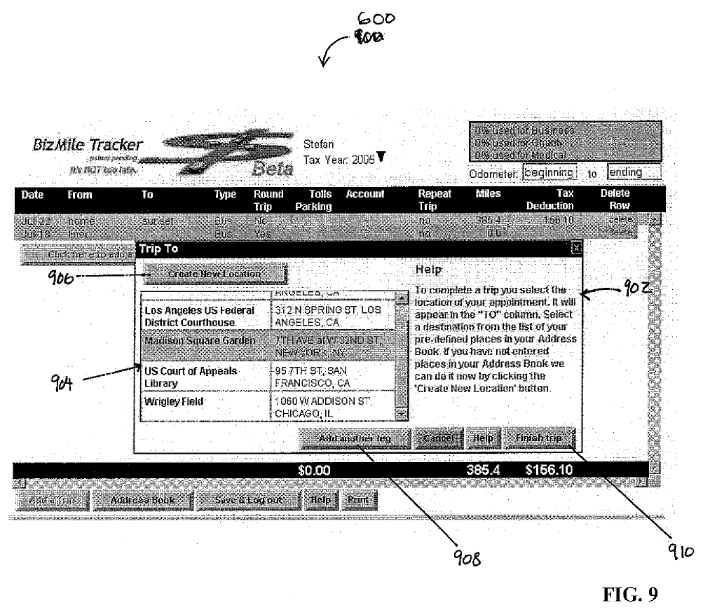

FIGS. 8 and 9 illustrate one embodiment of graphical user interfaces (GUI) for parts of this trip selection module 102. FIG. 8 illustrates one embodiment of a GUI for selection of the date of the user's trip. In this embodiment, the user can select the date of a trip from a Calendar window 800. Once the date has been selected, the user may move on to enter the remaining trip information by selecting the done button 802. After the date and starting address have been entered, the user may input destination information through a trip to window 902, shown in FIG. 9, which prompts the user to select an address from the user's address book 904, or input a new address by selecting the create new location button 906. The trip to window also allows a user to enter additional destinations on a multi-stop trip by selecting the Add another leg (segment) button 908, or, if the user is finished entering all of the destinations, he may complete the trip selection by selecting the Finish trip button 910.

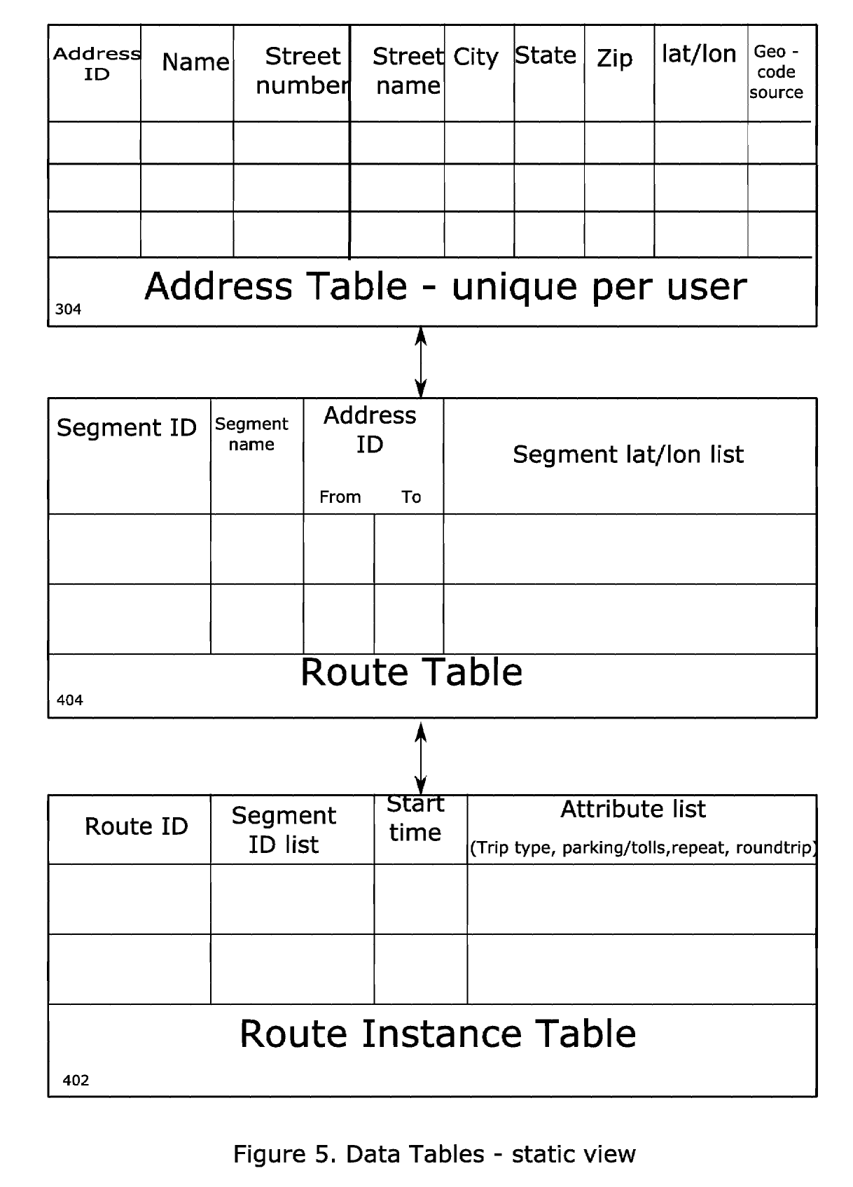

In one embodiment of the current system, an address book module 104 may be associated with a user's personal Web page within the system. This address book module 104 can store all, or selected, addresses input by the user for use in future routes or trips. An example of how addresses and other information are organized and stored in the address book module 104 is shown in FIG. 5. Moreover, a user may simply select from the addresses stored in the address book module 104 to input addresses for reimbursable or deductible trips.

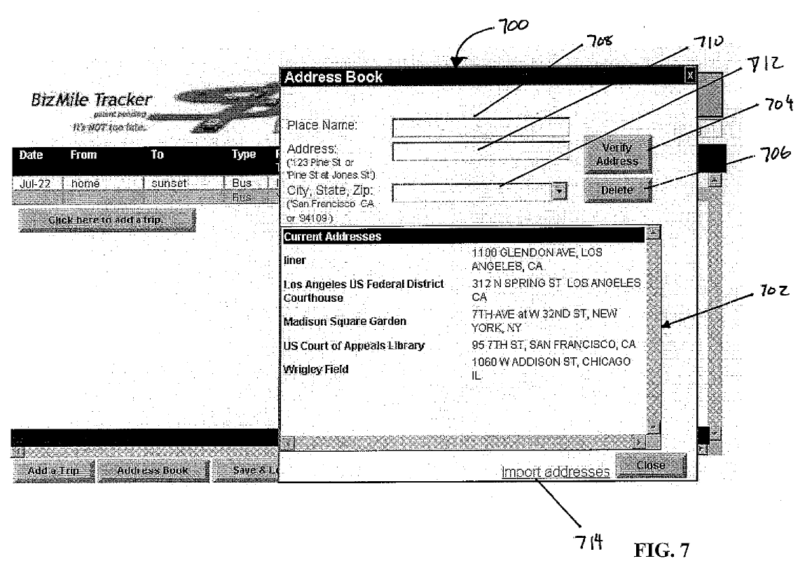

One embodiment of the GUI for the address book module 104 is represented in FIG. 7. In this embodiment, the address book GUI 700 displays user addresses currently stored in the address book module 104 in the current addresses window 702. A user may input new addresses by typing destination information in the fields provided, including the name of the destination 708, the address of the destination 710 and the city and state or the zip code of the destination 712. Once an address is input by a user, they are verified, as will be discussed later in this application, by selecting the verify address button 704. A user may also delete addresses from the address book module 104 by selecting the delete button 706 of the address book GUI 700.

Alternatively, a user may download their travel or route information from an electronic appointment diary, such as Microsoft Outlook, via an address import module 106. The address information stored in the appointment diary, along with address and client information stored in the user's address book module 104, may be automatically input into the trip selection module 102. In an alternate embodiment the user may prompt the download of their travel or route information to the address book module 104 through selection of an import addresses link 714 of the Address book GUI 700. The download and automatic input of this travel data significantly reduces the time needed to calculate travel expenses and eliminates the need for the user to duplicate data already entered into their appointment diary.

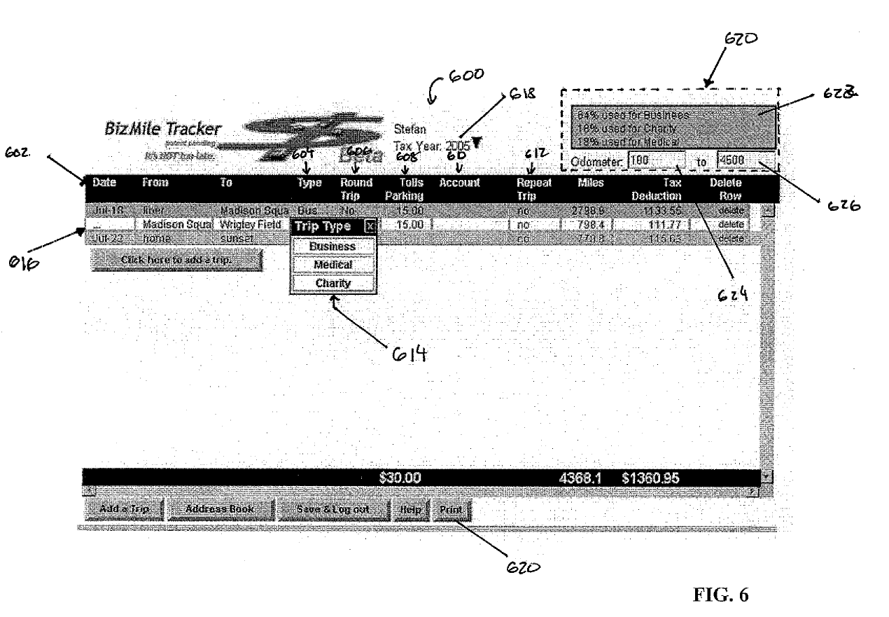

In one embodiment, the system has additional modules where the user may input additional data to supplement the input or downloaded travel data, such as: whether the trip is a roundtrip 118, parking and toll expenses 120, trip purpose or descriptive information 124 and whether the trip is a repeat trip 130. If the trip is a repeat trip (i.e., the same trip is made on a regular prescheduled basis), selecting the repeat trip 130 function causes a calendar 800 to display so that the repeat dates can be easily selected. In one embodiment, this additional travel information may be entered on the personal Web page of the user 600 as shown in FIG. 6. In a possible embodiment of the user's personal Web page 600, an information bar 602 indicates what type of trip information is contained within the columns of a trip summary table 616. A user may input additional information by selecting a cell in one of the columns for inputting additional information, such as the type column 604, round trip column 606, tolls/parking column 608, account column 610, or repeat trip column 612. In FIG. 6, a cell within the type column 604 has been selected and, as a result, the user may select the character of the trip through a Trip Type GUI 614. A similar GUI may be used to input other travel information, such as whether the trip is a round trip, parking and toll expenses, account information, and whether the trip is a repeat trip.

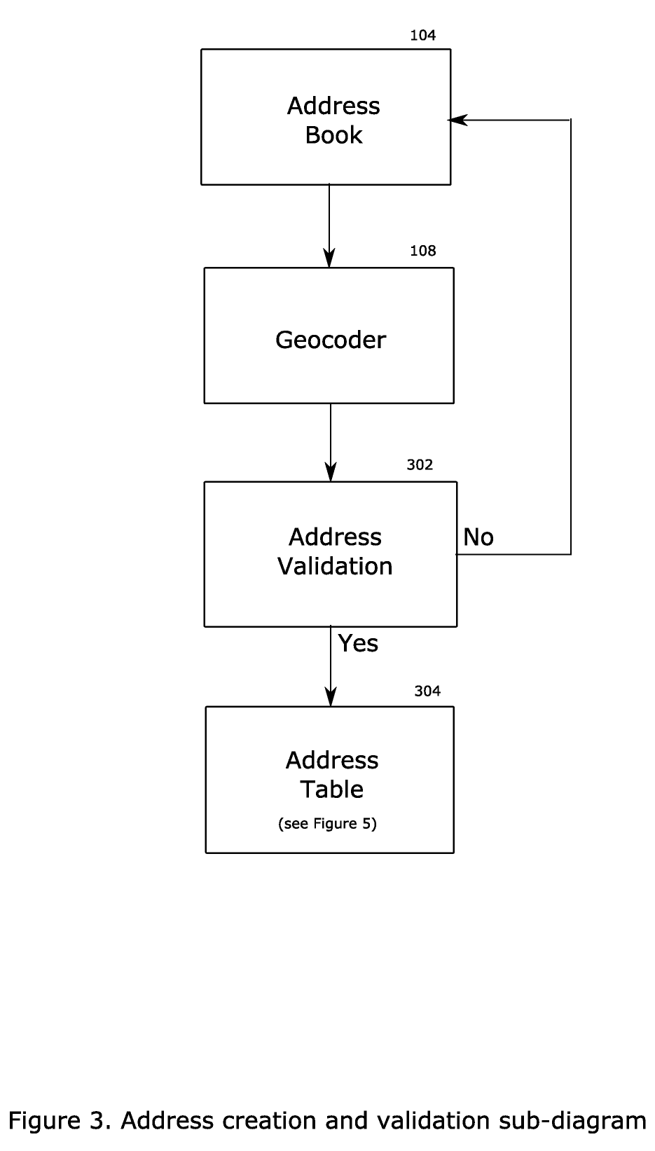

Once travel data are input into a user's personal Web page, mapping servers calculate the relative locations of the trip's starting point, intermediate points and end point. In one embodiment, the mapping servers use a geocoding module 108 to verify and locate the trip addresses. In an alternate embodiment, the geocoding module obtains the locations of the starting point, intermediate destination points, and end point through third party mapping applications such as Google Maps or MapQuest. FIG. 3 illustrates an embodiment where once addresses are input into the address book 104 and located by the geocoder 108, they are verified by a user through an address verification module 302. That is to say, if there is any ambiguity in the address input, the verification module 302 outputs the city, state and zip code or the nearest street intersection of an address and the user confirms that the correct determination has been made to eliminate errors such as those caused by similar street or city names in different states or by inaccurate entry of a numerical address. Alternately, the user can be presented with a map image and asked to select the correct location for an ambiguous address. Once the addresses are verified, the addresses are stored in an address table 304, shown in FIGS. 3-5. These data tables demonstrate a way of effectively organizing and associating the data, but it will be apparent to one of skill in the art that a number of other table organizations are equally applicable.

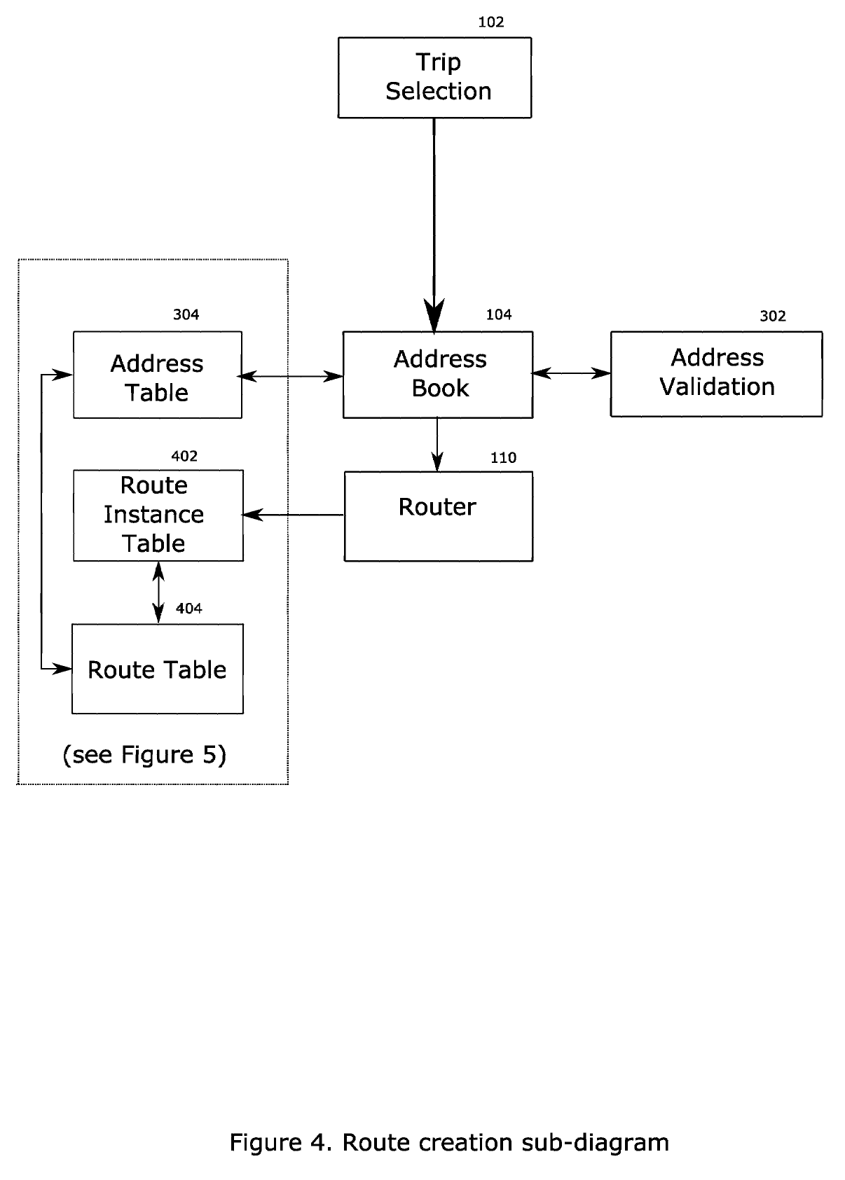

The address table 304 is coordinated with a route table 404, as shown in FIGS. 4 and 5, in which segment IDs are associated with segments of a given route. For example, if a user is going to be traveling a round trip route where they start at point A and stop at points B and C, separate segment IDs will be assigned to the route segments from A to B, B to C, and C back to A. A route instance table 402 is also associated with the route table 404 and assigns route segments that comprise a particular route ID along with other route attributes such as parking and toll expenses, trip purpose or descriptive information, and whether the route is a round trip.

The route instance table 402 is further associated with a router or routing module 110, which determines the appropriate paths for the route segments. In one embodiment, the routing module 110 uses pathing algorithms, such as those previously described, to find the shortest or fastest path between the addresses. In an alternate embodiment, the router 110 may reference third party routing software systems, such as Google maps or MapQuest to determine the path.

The router then forwards the path information regarding the route segments to a mileage calculation module 112, which calculates the mileage of each of the route segments. In one embodiment, the mileage calculation module 112 calculates the route segment mileage using methods previously described; alternatively, it may derive the mileage from third party mapping/routing software such as Google Maps or MapQuest. In either case, the mileage calculation module 112 may also calculate round trip mileage when such an indication is made by the user.

To derive expense information from route mileage data, an appropriate expense factor per mile is applied to the mileage data. However, the expense/deduction factor for an entire trip or for segments of a trip may be different depending on the purpose or character of the trip or each of the segments. For example, an employer may reimburse a user at a different rate for a trip which is considered deductible by the IRS, such as a charitable trip or trip for medical treatment than for a trip which is not deductible. To accommodate these different rates, one embodiment of the present system may have a Rate Calculation Module 114, which selects an appropriate rate apply to a route's mileage depending on a user's input into the Trip Type module 116.

In one embodiment, the route mileage data, and appropriate rate are then forwarded to a summary calculation module 122, which calculates the expense for a route by multiplying the expense rate with the route mileage. The summary calculation module 122 may also add additional route expenses, such as parking and toll expenses, to the calculated expense of a route. The summary calculation module 122 may repeat this calculation for a number or all of the routes within a given month, year, or in a group selected by the user. This expense information may be output into an expense report 126 to be submitted to a reimbursing party or for the user's records.

In one embodiment, as shown in FIG. 6, reimbursable or deductible trip information may be organized on the user's personal Web page 600 by tax year or by fiscal year. A user may select a year through a tax year icon 618 to display or select trip information in a given tax year. In this embodiment, a user can also display and print a print friendly copy of the expense report information displayed on their personal Web page 600 by selecting the print button 620. The user may also export expense data to a spreadsheet application, such as Microsoft Excel, through the print button 620.

In one embodiment of the inventive system, the summary calculation module 122 may also sort or perform statistical analysis on route mileage and expense data. For example, the summary calculation module 122 may sort mileage and expense data according to client, date, expense, or type. Moreover, the summary calculation module 122 may calculate statistics such as the average expense of business travel within a given month or year, the average expense per client, or other statistics as selected by the user.

In one embodiment of the inventive system an odometer module 128, shown in FIG. 1, may also provide the user with a statistical snapshot of their reimbursable, deductible, and non-deductible travel. The odometer module calculates the percentage of different use for a given odometer range of the user's automobile or of the user's entered trips. For example, if a user takes trips for charitable and business purposes, the odometer module may provide the user with the percentage of the automobile's use for each of these purposes within an odometer range selected by a user. This percentage may be useful when itemizing deductions or for the user's personal records.

A possible GUI for the odometer module 128 is shown in FIG. 6 as part of the user's personal Web page 600. The odometer GUI 620 is comprised of an odometer display 622, a starting odometer field 624, and an ending odometer field 626. The user enters the starting value of the odometer range in the starting odometer field 624 and the ending value of the odometer range in the ending odometer field 626. The odometer module 128 then calculates the percentage for each type of use in the odometer range input by the user as described above. The results of these calculations are then displayed to the user in the odometer display 622.

In an alternate embodiment of the inventive system GPS hardware and software can be used to track a user's route and mileage. Address data will still be input by a user or downloaded to an address book module 104, and longitude and latitude data for address may be derived from GIS data or other source. GPS hardware, such as in a GPS enabled phone or automobile navigation device, can track the actual position and route of the vehicle and mileage of the vehicle along the segments of a given route. These data can be stored in the GPS device and later output for use in the inventive system. In an alternate embodiment of the inventive system, the system may automatically track mileage with a GPS system, eliminating the need for a user to input address data. Moreover, GPS data may be acquired by the inventive system wirelessly, allowing real time tracking and calculation of expenses.

In one embodiment, the router 110 and mileage calculation module 112 may verify the mileage recorded by the GPS hardware by calculating the mileage of the shortest distance for the route segments. If the mileage data recorded by the GPS hardware is in line with the mileage data calculated by the router 110 and mileage calculation module 112, the mileage recorded by the GPS hardware will be accepted by the system and forwarded to the Summary calculation module 122 to calculate the route's expense. Otherwise, the system may reject the GPS mileage data and use the validated mileage data calculated by the router 110 and mileage calculation module 112 to calculate a route's expense. This could be an indication that the trip included personal side trips that do not qualify for the original business purposes of the main trip. In an alternative embodiment the system may average the GPS mileage data and the mileage calculated by the router 110 and mileage calculation module 112. Generally, the system will calculate the shortest distance for a given trip and will accept that distance as the validated distance to use for actual calculations of expense/deduction.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. For instance, many of the steps in the method described above, or modules in the inventive system, may be combined or re-ordered. For that reason, the illustrated embodiment has been set forth only for the purposes of example and should not be taken as limiting the invention. Therefore, it is to be understood that, within the scope of the appended claims, the invention may be practiced other than as specifically described herein.

I claim:

1. A method for accurately reconstructing mileage and travel expense reports comprising the steps of:
inputting addresses representative of a starting location, an end location and any intermediate destination points;
defining a route from the starting location and passing through any intermediate destination points to the end location;
defining segment(s) as portions of the route between any two of the input addresses;
obtaining a mileage length for each of the segments; and
calculating an expense/deduction associated with a user's trip along each segment.

2. The method of claim 1 where the route from the starting location through the intermediate destination points to the end location, is the shortest path passing through all of those points.

3. The method of claim 1 further comprising a step of generating or displaying a report of the expense/deduction associated with a user's trip along each segment.

4. The method of claim 1 further comprising a step of obtaining the geographic location for the starting location, each of any intermediate destination points, and the end location.

5. The method of claim 1 further comprising a step of inputting additional trip information for each of the segment(s).

6. The method of claim 5 further comprising a step of applying at least one of a plurality of mileage expense/deduction rates to each of the segments based on the input trip information.

7. The method of claim 5 where the addresses for each segment are manually input by the user.

8. The method of claim 1 where the addresses for each segment are downloaded.

9. A system for accurately reconstructing mileage and travel expense reports comprising:
input means for inputting addresses of a starting location, end location and any intermediate destination points;
routing means for defining a route from the starting location and passing through any intermediate destination points to the end location;
segmenting means for defining segment(s) as portions of the route between any two of the input addresses;
mileage calculation means for obtaining a length of each of the segments; and
summary calculation means for calculating an expense/deduction associated with a user's trip along each segment.

10. The system of claim 9, wherein the path from the starting location through the intermediate destination points to the end location is the shortest path passing through all of those points.

11. The system of claim 9 further comprising means for generating or displaying a report of the expense/deduction associated with a user's trip along each segment.

12. The system of claim 9 further comprising means for obtaining the geographic location of the starting location, each of any intermediate destination points, and the end location.

13. The system of claim 9 further comprising means for inputting additional trip information for each of the segment(s).

14. The system of claim 13 further comprising means for applying at least one of a plurality of mileage expense/deduction rates to each of the segments based on the input trip information.

15. The system of claim 13 where the addresses for each segment are manually input by the user.

16. The system of claim 7 where the addresses for each segment are downloaded.

17. An Internet based system for accurately reconstructing mileage and travel expense reports comprising:
an Internet enabled device that can connect to the Internet for the input and output of data;
at least one server connected to the Internet enabled device via the Internet for calculating mileage and expense/deduction data, and storing trip information, addresses of a starting location, an end location and any intermediate destination points, and mileage and trip information; and
software applications for defining a route from the starting location and passing through any intermediate destination points to the end location, for defining segments, for obtaining a mileage length of each of the segments, for applying one of a plurality of expense rates to apply to each of the segments based on the trip information, and for calculating an expense/deduction associated with a user's trip along each segment.

18. The system of claim 17 further comprising software for identifying the shortest path from the starting location through any intermediate destination points to the end location.

19. The system of claim 17 further comprising software for generating or displaying a report of the expense/deduction associated with a user's trip along each segment.

20. The system of claim 17 further comprising a software application for obtaining geographic locations of the starting location, each of the intermediate destination points, and the end location.

21. The system of claim 17, wherein the addresses and trip information are manually input.

22. The system of claim 17, wherein the addresses and trip information are downloaded.

23. The system of claim 17 further comprising an application for obtaining GPS data and calculating the mileage length of the segments from the GPS data.

24. The system of claim 17 further comprising has a software application for verifying the mileage or expense/deduction for a user.
